(19) United States
(12) Patent Application Publication
(10) Pub. No.: US 2024/0202106 A1
(43) Pub. Date: Jun. 20, 2024

(54) A Concept for Generating Code of Test Cases

(71) Applicant: Intel Corporation, Santa Clara, CA (US)

(72) Inventors: Junjun SHAN, Shanghai (CN); Minggui CAO, Shanghai (CN); Jian Jun CHEN, Shanghai (CN); Qian OUYANG, Shanghai (CN); Yi QIAN, Shanghai (CN); Xiangyang WU, Shanghai (CN)

(21) Appl. No.: 18/572,214

(22) PCT Filed: Oct. 15, 2021
(86) PCT No.: PCT/CN2021/124222

§ 371 Date: Dec. 20, 2023

(51) Int. Cl. G06F 11/36

(52) U.S. Cl. CPC G06F 11/3684

(57) ABSTRACT

Examples relate to an apparatus, a device, a method and a computer program for generating code for test cases for testing a function under test. The apparatus comprises circuitry configured to obtain a diagram representation of the function under test, select a plurality of symbols of interest from the diagram representation of the function under test, the symbols of interest being based on a pre-defined set of symbols of interest, and generate, for the symbols of interest, code of a plurality of test cases based on a pre-defined set of checks related to the pre-defined symbols of interest.

### FIELD

Examples relate to an apparatus, a device, a method, and a computer program for generating code for test cases for testing a function under test.

### BACKGROUND

One task in software development, in particular in software development of basic software, such as an operating system or a hypervisor in an x86 architecture with a strong hardware dependency, is to check the consistency of the software with a design spec in the software project. However, a high effort is required to understand the design and write test case code to check the consistency manually. In many projects, such as open source hypervisor projects, no semi-formal design specification and test code might exist, but only code.

In academic resource, formal verification is used for software to guarantee consistency. However, the effort required for formal verification is high and usually infeasible in projects in most industries.

### BRIEF DESCRIPTION OF THE FIGURES

Some examples of apparatuses and/or methods will be described in the following by way of example only, and with reference to the accompanying figures, in which

FIG. 1a shows a block diagram of an example of an apparatus or device for generating code for test cases for testing a function under test;

FIG. 1b shows a flow chart of an example of a method for generating code for test cases for testing a function under test;

FIG. 2 shows a flow chart of an example of a method for automatic test code generation; and

FIGS. 3a and 3b show a table of an example of a schema of a single test case.

### DETAILED DESCRIPTION

Some examples are now described in more detail with reference to the enclosed figures. However, other possible examples are not limited to the features of these examples described in detail. Other examples may include modifications of the features as well as equivalents and alternatives to the features. Furthermore, the terminology used herein to describe certain examples should not be restrictive of further possible examples.

Throughout the description of the figures same or similar reference numerals refer to same or similar elements and/or features, which may be identical or implemented in a modified form while providing the same or a similar function. The thickness of lines, layers and/or areas in the figures may also be exaggerated for clarification.

When two elements A and B are combined using an ‘or’, this is to be understood as disclosing all possible combinations, i.e. only A, only B as well as A and B, unless expressly defined otherwise in the individual case. As an alternative wording for the same combinations, “at least one of A and B” or “A and/or B” may be used. This applies equivalently to combinations of more than two elements.

If a singular form, such as “a”, “an” and “the” is used and the use of only a single element is not defined as mandatory either explicitly or implicitly, further examples may also use several elements to implement the same function. If a function is described below as implemented using multiple elements, further examples may implement the same function using a single element or a single processing entity. It is further understood that the terms “include”, “including”, “comprise” and/or “comprising”, when used, describe the presence of the specified features, integers, steps, operations, processes, elements, components and/or a group thereof, but do not exclude the presence or addition of one or more other features, integers, steps, operations, processes, elements, components and/or a group thereof.

In the following description, specific details are set forth, but embodiments of the technologies described herein may be practiced without these specific details. Well-known circuits, structures, and techniques have not been shown in detail to avoid obscuring an understanding of this description. “An embodiment/example,” “various embodiments/example,” “some embodiments/example,” and the like may include features, structures, or characteristics, but not every embodiment necessarily includes the particular features, structures, or characteristics.

Some embodiments may have some, all, or none of the features described for other embodiments. “First,” “second,” “third,” and the like describe a common element and indicate different instances of like elements being referred to. Such adjectives do not imply element item so described must be in a given sequence, either temporally or spatially, in ranking, or any other manner. “Connected” may indicate elements are in direct physical or electrical contact with each other and “coupled” may indicate elements co-operate or interact with each other, but they may or may not be in direct physical or electrical contact.

As used herein, the terms “operating”, “executing”, or “running” as they pertain to software or firmware in relation to a system, device, platform, or resource are used interchangeably and can refer to software or firmware stored in one or more computer-readable storage media accessible by the system, device, platform, or resource, even though the instructions contained in the software or firmware are not actively being executed by the system, device, platform, or resource.

The description may use the phrases “in an embodiment/example,” “in embodiments/example,” “in some embodiments/examples,” and/or “in various embodiments/examples,” each of which may refer to one or more of the same or different embodiments or examples. Furthermore, the terms “comprising,” “including,” “having,” and the like, as used with respect to embodiments of the present disclosure, are synonymous.

Various examples of the present disclosure relate to an automatic method or approach for converting a specific design format into test cases code.

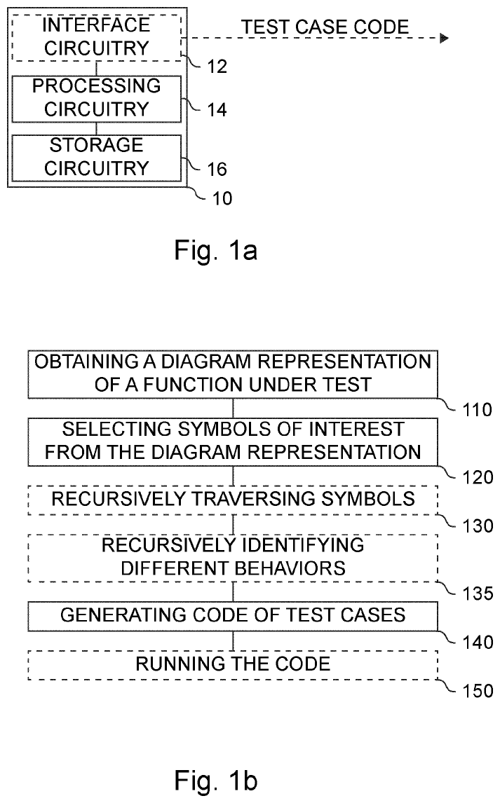

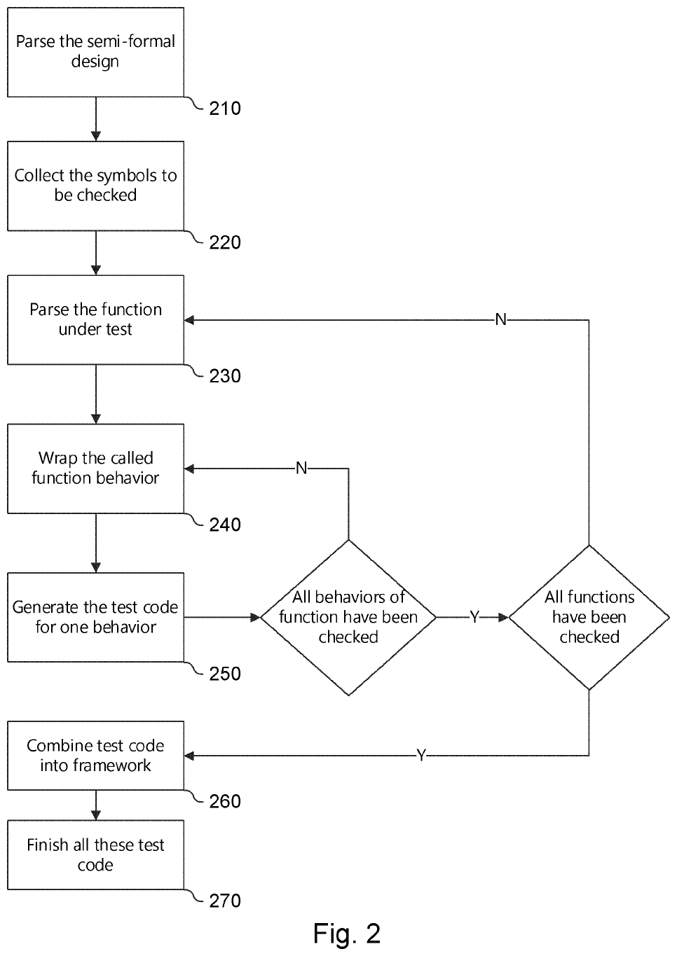

FIG. 1a shows a block diagram of an example of an apparatus 10 or device 10 for generating code for test cases for testing a function under test. The apparatus 10 comprises circuitry, configured to provide the functionality of the apparatus 10. For example, the apparatus 10 may comprise (optional) interface circuitry 12, processing circuitry 14 and storage circuitry 16. For example, the processing circuitry 14 may be coupled with the interface circuitry 12 and with the storage circuitry 16. For example, the processing circuitry 14 may be configured to provide the functionality of the apparatus 10, in conjunction with the interface circuitry 12 (for exchanging information, e.g. for providing information, such as the code of the test cases, or for receiving information on the function under test) and the storage circuitry 16 (for storing information). Likewise, the device 10 may comprise means that is/are configured to provide the functionality of the device 10. The components of the device 10 are defined as component means, which may correspond to, or implemented by, the respective structural components of the apparatus 10. For example, the device 10 may comprise means for processing 14, which may correspond to or be implemented by the processing circuitry 14, means for communicating 12, which may correspond to or be implemented by the interface circuitry 12, and means for storing information 16, which may correspond to or be implemented by the storage circuitry 16.

The circuitry/means is configured to obtain a diagram representation of the function under test. The circuitry/means is configured to select a plurality of symbols of interest from the diagram representation of the function under test. The symbols of interest are based on a pre-defined set of symbols of interest. The circuitry/means is configured to generate, for the symbols of interest, code of a plurality of test cases based on a pre-defined set of checks related to the pre-defined symbols of interest.

FIG. 1b shows a flow chart of an example of a corresponding method for generating code for test cases for testing a function under test. The method comprises obtaining 110 the diagram representation of the function under test. The method comprises selecting 120 the plurality of symbols of interest from the diagram representation of the function under test, with the symbols of interest being based on a pre-defined set of symbols of interest. The method comprises generating 140, for the symbols of interest, the code of the plurality of test cases based on a pre-defined set of checks related to the pre-defined symbols of interest.

In the following, the functionality of the apparatus 10, the device 10, the method and of a corresponding computer program is introduced in connection with the apparatus 10. Features introduced in connection with the apparatus 10 may be likewise included in the corresponding device 10, method and computer program.

Various examples of the present disclosure relate to the apparatus 10, device 10, method and computer program for generating code for test cases for testing a function under test. The proposed concept may be used to at least partially automate, and at least facilitate, the process of generating test cases based on a diagram representation of the function under code, which may substantially reduce the effort required for achieving a high test coverage. In particular, the proposed concept may be used to generate code of so-called unit tests for testing the function under test. Moreover, the software code of the function under test may be software code of a function of a software component that is part of a basic software, i.e., software that is executed in kernel space.

In general, unit tests are software-defined tests that are used to test whether a function under test behaves as expected. The function under test is usually parametrized, e.g., by setting one or more input parameters or by setting one or more global variables, and an expected result with respect to the one or more input parameters and/or one or more global variables, is defined. The unit test then executes the function under test, and checks whether the behavior of the function under test matches the expected result, e.g., with respect to a return value, with respect to (sub-) functions being called, with respect to global memory being impacted etc. In particular, unit tests that are used to test basic software may clearly define the expected results, also with respect to global memory and functions being called, as such basic software may directly access hardware functionality, in addition to other functions of the operating system/hypervisor, which may increase the complexity of generating such unit tests.

The proposed concept starts with a semi-formal notation of the function under test that is defined as a diagram. In the diagram, each symbol of the function under test may be a separate component of the diagram, connected through connectors between the symbols. Accordingly, the diagram representation of the function under test may be a graph representation of the function under test, with the symbols of the function under test being the vertices of the graph, and with the connections between the symbols being the edges of the graph. For example, the diagram representation of the function under test may be based on the unified modeling language (UML). For example, a text based UML modeling tool, such as plantuml, may be used to generate the diagram representation. For example, the circuitry may be configured to, using a text-based UML modeling tool, obtain the diagram representation by transforming a program code of the function under test into the diagram representation of the function under test. Similarly, the method may comprise obtaining the diagram representation by transforming the program code of the function under test into the diagram representation of the function under test.

The diagram representation is then scanned for the symbols of interest. These symbols of interest are selected based on the pre-defined set of symbols of interest, which species types and characteristics of symbols that are of interest with respect to the generation of test cases. In other words, the pre-defined set of symbols may specify a type and/or a characteristic of symbols that are deemed to be symbols of interest. For example, the pre-defined set of symbols of interest may comprise one or more of a symbol of interest related to a branch condition, a symbol of interest related to an external function call, a symbol of interest related to an input/output parameter change, a symbol of interest related to a global variable change, a symbol of interest related to one or more pre-conditions imposed on a software or hardware environment, a symbol of interest related to a sequence of function calls and a symbol of interest related to a flow of a transition between different functions. The types and characteristics of the above symbols of interest are of particular interest for the generation of test cases, as they either define different branches to be tested, or as they relate to symbols that have an impact that can (or should) be checked in a test case. For example, the symbol of interest related to a branch condition may be used to identify the different branches to be checked, and the symbol of interest related to an external function call, the symbol of interest related to an input/output parameter change, the symbol of interest related to a global variable change, the symbol of interest related to one or more pre-conditions imposed on a software or hardware environment, the symbol of interest related to a sequence of function calls and the symbol of interest related to a flow of a transition between different functions may have an impact that is to be checked in a test case. For example, pattern matching may be used to select the symbols of interest, with the patterns being used for the pattern matching being based on the pre-defined set of symbols of interest.

For example, the set of symbols of interest may comprise a symbol of interest related to a branch condition. In programming, when code defines different branches, these different branches often lead to different sequences of events. For example, two commonly used branch operators are the “if” operator and the “switch case” operator. The “if” operator is commonly used to make the execution of a portion of the code conditional on the condition defined by the “if” operator. It commonly leads to two different branches—a first branch that is taken if the condition defined by the “if” operator is fulfilled, and a second branch that is taken if the condition defined by the “if” operator is not fulfilled. The “switch case” operator is used to distinguish multiple cases, leading to multiple branches. For example, in a “switch case” operation, 1 . . . n cases are defined, along with a default case, leading to n+1 different branches. For example, each branch (i.e., branching outcome) may be used to generate a separate test case. In many cases, a function under test may comprise multiple symbols related to branch conditions. Correspondingly, a cartesian product of the branches of the different symbols related to branch conditions may be calculated, leading to separate test cases for each element of the cartesian product.

The other symbols of interest relate to symbols that have an impact that can be checked as part of a test case. For example, a symbol of interest related to an external function call has different aspects that are of interest with respect to test cases. For example, a behavior (i.e., an impact) of the external function call, an input parameter of the external function call, an execution sequence dependency of the external function call (i.e., in which order is the external function call performed relative to other function calls or variable changes), and/or an impact of the function under test on global memory or an external resource (e.g., a memory or a state of a hardware device) may be checked in a test case.

With respect to a symbol of interest related to an input/output parameter change, a check may be performed on whether the input parameter has been set when the function under test is called. With respect to a symbol of interest related to a global variable change, a check for ascertaining that a value of one or more global variables is set before the function under test is called (to check for problems where a variable is not initialized), a check for ascertaining a correctness of the global variable change (to check that the change of the variable is correct), and/or a check related to an impact of the function under test on global memory (i.e., which global variables or external resources are accessed? Is a global variable set before the function under test accesses it? etc.) may be performed. With respect to a symbol of interest related to one or more pre-conditions imposed on a software or hardware environment, a check related to the one or more pre-conditions imposed on the software environment may be performed (i.e., what happens when the conditions are met and what happens if the conditions are not met). With respect to a symbol of interest related to a sequence of function calls and a symbol of interest related to a flow of a transition between different functions, a check may be performed to ascertain the correct sequence of the function calls and the correct transition between the different functions.

In the proposed concept, a mapping between the symbols of interest of a pre-defined set of checks is used to generate the code of the test cases. For example, the pre-defined set of checks may define the checks being included in the code of the test cases. Moreover, as outlined above, some of the pre-defined symbols of interest, such as the symbol of interest related to a branching condition and/or the symbol of interest related to a software pre-condition, may be used to define the separate test cases. The circuitry is configured to generate, for the symbols of interest, the code of a plurality of test cases based on the pre-defined set of checks related to the pre-defined symbols of interest. In particular, the circuitry may be configured to identify the separate test cases based on the selected symbols of interest (in particular the symbol of interest related to a branching condition and/or the symbol of interest related to a software pre-condition). For example, the circuitry may be configured to generate the code for the plurality of test cases based one or more symbols of interest related to branch conditions. Accordingly, the method may comprise generating 140 the code for the plurality of test cases based one or more symbols of interest related to branch conditions. For example, for each branch (or combination of branches) a separate test case may be identified, and code for a separate test case may be generated.

Once the test cases are identified, the code of the test cases may be generated based on the mapping between the pre-defined set of checks and the pre-defined symbols of interest. For example, the selected symbols of interest may be used to look up corresponding checks from the pre-defined set of checks.

For example, as outlined above, the pre-defined set of symbols of interest may comprise a symbol of interest related to an external function call. The corresponding pre-defined set of checks may comprise one or more of a check related to a behavior of the external function call, a check related to an input parameter of the external function call, a check related to an execution sequence dependency of the external function call, and a check related to an impact of the function under test on global memory or an external resource (both of which may be affected by the external function call). For example, one or more of the check related to a behavior of the external function call, the check related to an input parameter of the external function call, the check related to an execution sequence dependency of the external function call, and the check related to an impact of the function under test on global memory or an external resource may be inserted into the code of the test cases if the selected symbols of interest comprise a symbol of interest related to an external function call.

In some examples, the pre-defined set of symbols of interest comprises a symbol of interest related to an input/output parameter change. The corresponding pre-defined set of checks may comprise a check for ascertaining that an input parameter is set before the function under test is called. Accordingly, the check for ascertaining that an input parameter is set before the function under test is called may be inserted into the code of the test cases if the selected symbols of interest comprise a symbol of interest related to an input/output parameter change.

In some examples, the pre-defined set of symbols of interest comprises a symbol of interest related to a global variable change. The corresponding pre-defined set of checks may comprise one or more of a check for ascertaining that a value of one or more global variables is set before the function under test is called and a check for ascertaining a correctness of the global variable change. Accordingly, one or more of the check for ascertaining that a value of one or more global variables is set before the function under test is called and the check for ascertaining a correctness of the global variable change may be inserted into the code of the test cases if the selected symbols of interest comprise a symbol of interest related to a global variable change.

In some examples, the pre-defined set of symbols of interest comprises a symbol of interest related to one or more pre-conditions imposed on a software environment. The corresponding pre-defined set of checks may comprise a check related to the one or more pre-conditions imposed on the software environment, i.e., a check for ascertaining that the pre-conditions imposed on the software environment are met. Accordingly, the check related to the one or more pre-conditions imposed on the software environment may be inserted into the code of the test cases if the selected symbols of interest comprise a symbol of interest related to one or more pre-conditions imposed on a software environment.

In some examples, the pre-defined set of symbols of interest comprises a symbol of interest related to a sequence of function calls and/or a symbol of interest related to a flow of a transition between different functions. The corresponding pre-defined set of checks may comprise a check related to the sequence of function calls (e.g., a check for ascertaining that the function calls are executed in the correct sequence) and/or a check related to the flow of the transition between different functions (e.g., a check for ascertaining that the functions transition as expected). Accordingly, the check related to the sequence of function calls may be inserted into the code of the test cases if the selected symbols of interest comprise a symbol of interest related to a sequence of function calls. The check related to the flow of the transition between different functions may be inserted into the code of the test cases if the selected symbols of interest comprise a symbol of interest related to a flow of a transition between different functions.

Moreover, some general checks may be inserted into the code of the test cases. For example, the pre-defined set of checks comprises one or more of a check related to a change related to an output variable in the function under test and a check related to a return value of the function under test. For example, if the function under test comprises a symbol related to an output variable in the function under test, the check related to the output variable may be inserted into the code of the test cases. If the function under test comprises a symbol related to a return value of the function under test, the check related to the return value of the function under test may be inserted into the code of the test cases.

In many software projects, functions of the software projects call other functions of the software project. Moreover, some functions comprise so-called blocks of code, which is code that is tied together via some special symbols/characters, such as curly braces. In the diagram representation of the function under test, these other functions or blocks of code can be expanded, leading to a graph where the respective function calls and blocks fan out from an abstract symbol representing the function calls and blocks to individual symbols representing the content of the other functions or blocks of code. The proposed concept may use a recursive approach to follow the symbols, following the calls to the other functions and/or entering into the blocks of code. For example, the circuitry may be configured to recursively traverse the symbols of interest to generate the code for the plurality of test cases. Accordingly, the method may comprise recursively traversing 130 the symbols of interest to generate the code for the plurality of test cases. For example, if the function under test calls another function (that is part of the software code), a separate test case may be created for this function in isolation, in addition to the test vector comprising the function in the context of the function under test. Moreover, if a symbol related to a branch condition is encountered, separate test cases may be created for each branch, and the respective branches may be recursively processed to create additional test cases (in case the branch comprises another symbol of interest related to a branch). These different branches, which lead to different test cases, are also denoted different “behaviors” of the function under test (or of a function or block of code called by the function under test). The circuitry may be configured to recursively identify a plurality of different behaviors of the function under test (i.e., a plurality of different branches or combination of branches included in the function under test), and to generate the code for the plurality of test cases based on the plurality different behaviors of the function under test, with each test case representing one behavior (i.e., one branch or combination of branches) of the function under test. Accordingly, the method may comprise recursively identifying 135 a plurality of different behaviors of the function under test and generating 140 the code for the plurality of test cases based on the plurality different behaviors of the function under test. For example, for each behavior (i.e., branch or combination of branches), a separate test case may be identified, and code may be generated for the separate test cases.

So far, a skeleton has been created that provides test cases to cover various aspects of the functions under test. However, some of the test cases, such as test cases comprising a check on the correctness of a variable change, a check on a correctness of a return value or output variable, a check on an impact of a function call on global memory and/or an external resource, may require additional information on expected results of the function under test, such as the correct value of a variable change, the correct return value or output value, and the correct impact of the function call on the global memory. In some examples, these values may be automatically generated (e.g., supervised by the user). In other words, the circuitry may be configured to determine one or more expected results of the test cases, and to include information on the expected results in the code of the test cases. Accordingly, the method may comprise determining one or more expected results of the test cases and including information on the expected results in the code of the test cases. In some other cases, the expected results may be provided by the user. In this case, the generated code of the test case may comprise a comment where the expected results are to be inserted.

Finally, the code of the test cases may be run (i.e., executed). For example, the circuitry may be configured to run the code for the plurality of test cases on the function under test. In other words, the method comprises running 150 the code for the plurality of test cases on the function under test. For example, the circuitry may be configured to run a plurality of unit tests based on the code for the plurality of test cases. The code of the plurality of test cases may thus specify a plurality of unit tests. The code of the test cases, e.g., the unit tests, may be executed when the software code is changed, e.g., automatically upon compilation, manually (initiated by the user), or automatically within a continuous integration framework.

The interface circuitry 12 or means for communicating 12 may correspond to one or more inputs and/or outputs for receiving and/or transmitting information, which may be in digital (bit) values according to a specified code, within a module, between modules or between modules of different entities. For example, the interface circuitry 12 or means for communicating 12 may comprise circuitry configured to receive and/or transmit information.

For example, the processing circuitry 14 or means for processing 14 may be implemented using one or more processing units, one or more processing devices, any means for processing, such as a processor, a computer or a programmable hardware component being operable with accordingly adapted software. In other words, the described function of the processing circuitry 14 or means for processing may as well be implemented in software, which is then executed on one or more programmable hardware components. Such hardware components may comprise a general purpose processor, a Digital Signal Processor (DSP), a micro-controller, etc.

For example, the storage circuitry 16 or means for storing information 16 may comprise at least one element of the group of a computer readable storage medium, such as a magnetic or optical storage medium, e.g. a hard disk drive, a flash memory, Floppy-Disk, Random Access Memory (RAM), Programmable Read Only Memory (PROM), Erasable Programmable Read Only Memory (EPROM), an Electronically Erasable Programmable Read Only Memory (EEPROM), or a network storage.

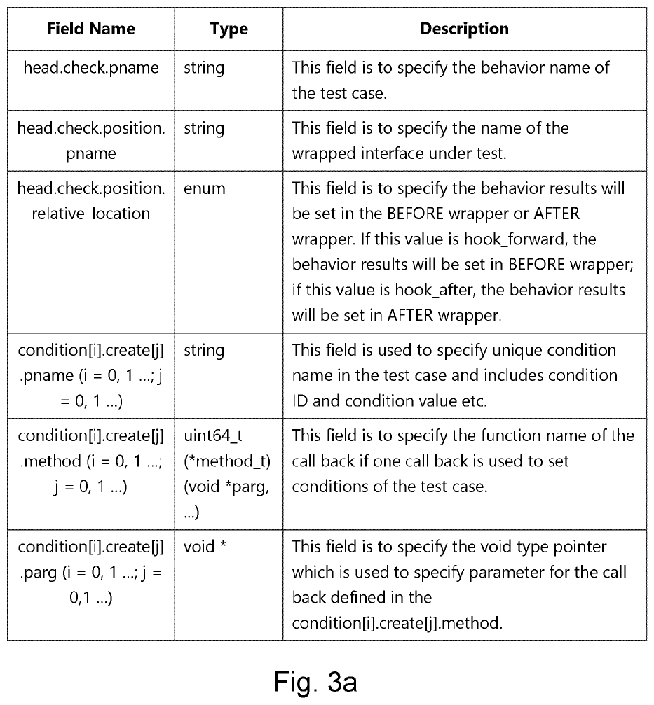

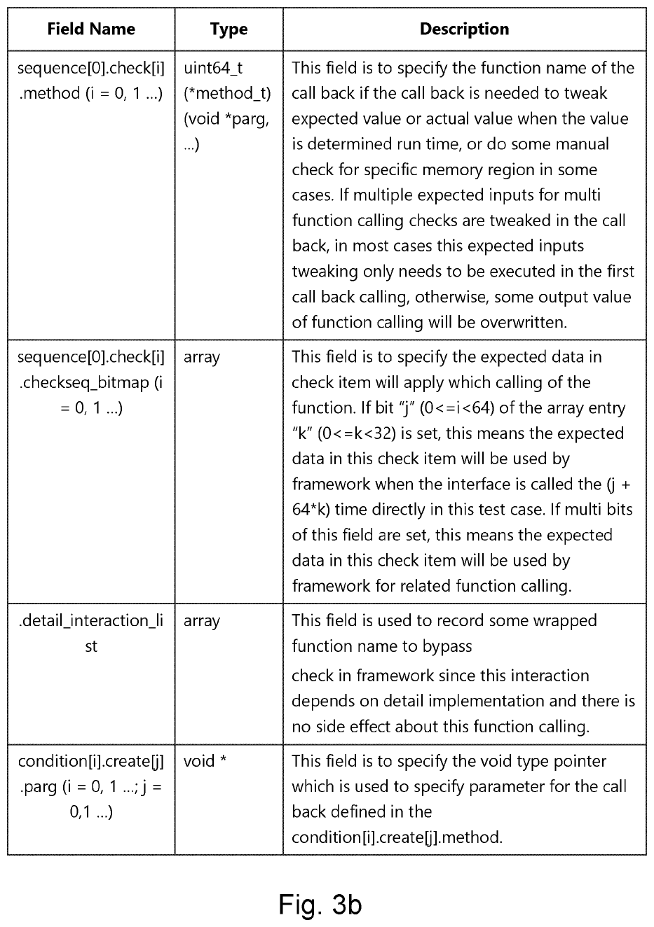

More details and aspects of the apparatus 10, device 10, method and computer program are mentioned in connection with the proposed concept or one or more examples described above or below (e.g. FIG. 2 or 3). The apparatus 10, device 10, method and computer program may comprise one or more additional optional features corresponding to one or more aspects of the proposed concept or one or more examples described above or below.

In the following, an example of an implementation of the concept proposed in connection with FIGS. 1a and 1b is given.

The proposed algorithm is based on analyze a semi-formal design (diagram) and generate test case code automatically for consistency check. The coverage of the test cases may be 100% or may even be customized with any percentage on demand. The proposed concept employs a lightweight method and approach, which can be used in both projects in the industry and open-source projects. The proposed concept was used in a hypervisor project to reduce the resources required for the generation of test cases by approximately 50%. It can be used internally in companies, but also be shared with customers and technology partners that want to adapt the software.

As a first task, the design the software may be specified with a semi-formal notation (e.g., the diagram representation), such as a Unified Modeling Language (UML) diagram, using software such as plantuml, which is an open-source tool allowing users to create diagrams from a plain text language.

One or more of the following aspects may be be checked in the semi-formal design and marked as critical symbols: (1) branch condition, (2) external function call, (3) input/output parameter change, (4) global variable change, (5) pre-conditions, (6) function call sequence and (7) data flow.

Then, the algorithm may parse the critical symbols (e.g. characters) above and generate corresponding test case code to check one or more of the following aspects: (1) The values of global variables should be set up before the function is called under test, (2) The input parameters shall be set up before the function is called under test, (3) The initial software conditions before the function under test is called, (4) The behavior and input parameters of these external interfaces which are called by the function under test, (5) The execution sequence dependency of these external interfaces mentioned in (4), (6) The changes of global variables in the function under test, (7) The changes of output variables in the function under test, (8) The side effect of software after the function under test is called (e.g., the impact on global memory and external resources), (9) The return value shall be checked after the function under test is called.

An example of a schema for a test case is shown in FIGS. 3a and 3b.

With respect to FIG. 2, the method to generate the test code is introduced. FIG. 2 shows a flow chart of an example of a method for automatic test code generation. The method may comprise one or more of the following tasks:
(1) Analyze the semi-formal design spec to collect the symbols (see FIG. 2: “Parse the semi-formal design” (210) and “Collect the symbols to be checked” (220), with the “symbols to be checked” corresponding to the “symbols of interest”, for example),
(2) Parse the function under test and identify the function behaviors (see FIG. 2: “Parse the function under test” (230), with the different behaviors corresponding to the different branches or combination of branches, for example),
(3) Warp one function behavior (FIG. 2 240, e.g., apply the checks appropriate for the symbols of interest of the function with respect to the behavior),
(4) Generate test code for the behavior (FIG. 2 250),
(5) If all behaviors of the function have been checked, go to next task, else repeat tasks 3 & 4,
(6) If all functions have been checked, go to next task, else repeat tasks 3-5,
(7) Combine all these test code in one test framework (FIGS. 2 260), and
(8) Finalize all test code (FIG. 2 270).

FIGS. 3a and 3b show a table of an example of a schema of a single test case. FIGS. 3a and 3b show the same table, which is split into two halves due to its size. FIGS. 3a and 3b show three columns, a “field name” column, a “type” column, and a “description” column. In the following, the different fields of the schema of the test case, according to the example, are introduced in more detail. The schema of the test case may comprise one or more of the following fields:

For example, the schema of the test case may comprise the field ‘head.check.pname” of type “string”, which is used to specify the behavior name of the test case.

For example, the schema of the test case may comprise the field “head.check.position.pname” of type “string”, which is used to specify the name of the wrapped interface under test.

For example, the schema of the test case may comprise the field “head.check.position.relative_location” of type “enum” which is used to specify the behavior results will be set in the BEFORE wrapper or AFTER wrapper. If this value is hook_forward, the behavior results will be set in BEFORE wrapper; if this value is hook_after, the behavior results will be set in AFTER wrapper.

For example, the schema of the test case may comprise the field(s) “condition[i].create[j].pname” for i=0, 1 . . . and j=0, 1 . . . , of type “string”, which is/are used to specify a unique condition name in the test case and includes condition ID and condition value etc.

For example, the schema of the test case may comprise the field(s) “condition[i].create[j].method” for i=0, 1 . . . and j=0, 1 . . . of type “uint64_t (*method_t)(void*parg, . . . )”, which is/are used to specify the function name of the call back if one call back is used to set conditions of the test case.

For example, the schema of the test case may comprise the field(s) “condition[i].create[j].parg” for i=0, 1 . . . and j=0,1 . . . of type “void*”, which is/are used to specify the void type pointer which is used to specify parameter for the call back defined in the condition[i].create[j].method.

For example, the schema of the test case may comprise the field(s) “sequence[0].check[i].method” for i=0, 1 . . . of type “uint64_t (*method_t)(void*parg, . . . )”, which is/are used to specify the function name of the call back if the call back is needed to tweak expected value or actual value when the value is determined run time, or do some manual check for specific memory region in some cases. If multiple expected inputs for multi function calling checks are tweaked in the call back, in most cases this expected inputs tweaking only needs to be executed in the first call back calling, otherwise, some output value of function calling will be overwritten.

For example, the schema of the test case may comprise the field(s) “sequence[0].check[i].checkseq_bitmap” for i=0, 1 . . . of type “array”, which is/are used to specify the expected data in check item will apply which calling of the function. If bit “j” (0<=j<64) of the array entry “k” (0<=k<32) is set, this means the expected data in this check item will be used by framework when the interface is called the (j+64*k) time directly in this test case. If multi bits of this field are set, this means the expected data in this check item will be used by framework for related function calling.

For example, the schema of the test case may comprise the field “detail_interaction_list” of type “array”, which is used to record some wrapped function name to bypass check in framework since this interaction depends on detail implementation and there is no side effect about this function calling.

For example, the schema of the test case may comprise the field(s) “condition[i].create[j].parg” for i=0, 1 . . . ; j=0,1 . . . of type “void*”, which is used to specify the void type pointer which is used to specify parameter for the call back defined in the condition[i].create[j].method.

The proposed concept provides a new automatic algorithm to convert a specific design format into test cases code to achieve the desired coverage. It may reduce the verification and design workload and improve the quality of software in industrial and open-source project both inside and outside of a company.

For example, the proposed method and algorithm may implement the method of FIG. 1b. The apparatus 10 or device 10 of FIG. 1a may be configured to perform the proposed method and algorithm, for example.

More details and aspects of the proposed method and algorithm are mentioned in connection with the proposed concept or one or more examples described above or below (e.g. FIG. 1a or 1b). The proposed method and algorithm may comprise one or more additional optional features corresponding to one or more aspects of the proposed concept or one or more examples described above or below.

In the following, some examples of the proposed concept are given.

An example (e.g., example 1) relates to an apparatus (10) for generating code for test cases for testing a function under test, the apparatus comprising circuitry configured to obtain a diagram representation of the function under test. The circuitry is configured to select a plurality of symbols of interest from the diagram representation of the function under test, the symbols of interest being based on a pre-defined set of symbols of interest. The circuitry is configured to generate, for the symbols of interest, code of a plurality of test cases based on a pre-defined set of checks related to the pre-defined symbols of interest.

Another example (e.g., example 2) relates to a previously described example (e.g., example 1) or to any of the examples described herein, further comprising that the pre-defined set of symbols of interest comprises one or more of a symbol of interest related to a branch condition, a symbol of interest related to an external function call, a symbol of interest related to an input/output parameter change, a symbol of interest related to a global variable change, a symbol of interest related to one or more pre-conditions imposed on a software or hardware environment, a symbol of interest related to a sequence of function calls and a symbol of interest related to a flow of a transition between different functions.

Another example (e.g., example 3) relates to a previously described example (e.g., one of the examples 1 to 2) or to any of the examples described herein, further comprising that the pre-defined set of symbols of interest comprises a symbol of interest related to a global variable change, the pre-defined set of checks comprising one or more of a check for ascertaining that a value of one or more global variables is set before the function under test is called and a check for ascertaining a correctness of the global variable change.

Another example (e.g., example 4) relates to a previously described example (e.g., one of the examples 1 to 3) or to any of the examples described herein, further comprising that the pre-defined set of symbols of interest comprises a symbol of interest related to an input/output parameter change, the pre-defined set of checks comprising a check for ascertaining that an input parameter is set before the function under test is called.

Another example (e.g., example 5) relates to a previously described example (e.g., one of the examples 1 to 4) or to any of the examples described herein, further comprising that the pre-defined set of symbols of interest comprises a symbol of interest related to one or more pre-conditions imposed on a software environment, the pre-defined set of checks comprising a check related to the one or more pre-conditions imposed on the software environment.

Another example (e.g., example 6) relates to a previously described example (e.g., one of the examples 1 to 5) or to any of the examples described herein, further comprising that the pre-defined set of symbols of interest comprises a symbol of interest related to an external function call, the pre-defined set of checks comprising one or more of a check related to a behavior of the external function call, a check related to an input parameter of the external function call, and a check related to an execution sequence dependency of the external function call.

Another example (e.g., example 7) relates to a previously described example (e.g., one of the examples 1 to 6) or to any of the examples described herein, further comprising that the pre-defined set of symbols of interest comprises a symbol of interest related to an external function call and/or a symbol of interest related to a global variable change, the pre-defined set of checks comprising a check related to an impact of the function under test on global memory or an external resource.

Another example (e.g., example 8) relates to a previously described example (e.g., one of the examples 1 to 7) or to any of the examples described herein, further comprising that the pre-defined set of checks comprises one or more of a check related to a change related to an output variable in the function under test and a check related to a return value of the function under test.

Another example (e.g., example 9) relates to a previously described example (e.g., one of the examples 1 to 8) or to any of the examples described herein, further comprising that the circuitry is configured to generate the code for the plurality of test cases based one or more symbols of interest related to branch conditions.

Another example (e.g., example 10) relates to a previously described example (e.g., one of the examples 1 to 9) or to any of the examples described herein, further comprising that the circuitry is configured to recursively traverse the symbols of interest to generate the code for the plurality of test cases.

Another example (e.g., example 11) relates to a previously described example (e.g., example 10) or to any of the examples described herein, further comprising that the circuitry is configured to recursively identify a plurality of different behaviors of the function under test, and to generate the code for the plurality of test cases based on the plurality different behaviors of the function under test, each test case representing one behavior of the function under test.

Another example (e.g., example 12) relates to a previously described example (e.g., one of the examples 1 to 11) or to any of the examples described herein, further comprising that the diagram representation of the function under test is based on the unified modeling language.

Another example (e.g., example 13) relates to a previously described example (e.g., one of the examples 1 to 12) or to any of the examples described herein, further comprising that the circuitry is configured to run the code for the plurality of test cases on the function under test.

An example (e.g., example 14) relates to a device (10) for generating code for test cases for testing a function under test, the device comprising means configured to obtain a diagram representation of the function under test. The means is configured to select a plurality of symbols of interest from the diagram representation of the function under test, the symbols of interest being based on a pre-defined set of symbols of interest. The means is configured to generate, for the symbols of interest, code of a plurality of test cases based on a pre-defined set of checks related to the pre-defined symbols of interest.

Another example (e.g., example 15) relates to a previously described example (e.g., example 14) or to any of the examples described herein, further comprising that the pre-defined set of symbols of interest comprises one or more of a symbol of interest related to a branch condition, a symbol of interest related to an external function call, a symbol of interest related to an input/output parameter change, a symbol of interest related to a global variable change, a symbol of interest related to one or more pre-conditions imposed on a software or hardware environment, a symbol of interest related to a sequence of function calls and a symbol of interest related to a flow of a transition between different functions.

Another example (e.g., example 16) relates to a previously described example (e.g., one of the examples 14 to 15) or to any of the examples described herein, further comprising that the pre-defined set of symbols of interest comprises a symbol of interest related to a global variable change, the pre-defined set of checks comprising one or more of a check for ascertaining that a value of one or more global variables is set before the function under test is called and a check for ascertaining a correctness of the global variable change.

Another example (e.g., example 17) relates to a previously described example (e.g., one of the examples 14 to 16) or to any of the examples described herein, further comprising that the pre-defined set of symbols of interest comprises a symbol of interest related to an input/output parameter change, the pre-defined set of checks comprising a check for ascertaining that an input parameter is set before the function under test is called.

Another example (e.g., example 18) relates to a previously described example (e.g., one of the examples 14 to 17) or to any of the examples described herein, further comprising that the pre-defined set of symbols of interest comprises a symbol of interest related to one or more pre-conditions imposed on a software environment, the pre-defined set of checks comprising a check related to the one or more pre-conditions imposed on the software environment.

Another example (e.g., example 19) relates to a previously described example (e.g., one of the examples 14 to 18) or to any of the examples described herein, further comprising that the pre-defined set of symbols of interest comprises a symbol of interest related to an external function call, the pre-defined set of checks comprising one or more of a check related to a behavior of the external function call, a check related to an input parameter of the external function call, and a check related to an execution sequence dependency of the external function call.

Another example (e.g., example 20) relates to a previously described example (e.g., one of the examples 14 to 19) or to any of the examples described herein, further comprising that the pre-defined set of symbols of interest comprises a symbol of interest related to an external function call and/or a symbol of interest related to a global variable change, the pre-defined set of checks comprising a check related to an impact of the function under test on global memory or an external resource.

Another example (e.g., example 21) relates to a previously described example (e.g., one of the examples 14 to 20) or to any of the examples described herein, further comprising that the pre-defined set of checks comprises one or more of a check related to a change related to an output variable in the function under test and a check related to a return value of the function under test.

Another example (e.g., example 22) relates to a previously described example (e.g., one of the examples 14 to 21) or to any of the examples described herein, further comprising that the means is configured to generate the code for the plurality of test cases based one or more symbols of interest related to branch conditions.

Another example (e.g., example 23) relates to a previously described example (e.g., one of the examples 14 to 22) or to any of the examples described herein, further comprising that the means is configured to recursively traverse the symbols of interest to generate the code for the plurality of test cases.

Another example (e.g., example 24) relates to a previously described example (e.g., example 23) or to any of the examples described herein, further comprising that the means is configured to recursively identify a plurality of different behaviors of the function under test, and to generate the code for the plurality of test cases based on the plurality different behaviors of the function under test, each test case representing one behavior of the function under test.

Another example (e.g., example 25) relates to a previously described example (e.g., one of the examples 14 to 24) or to any of the examples described herein, further comprising that the diagram representation of the function under test is based on the unified modeling language.

Another example (e.g., example 26) relates to a previously described example (e.g., one of the examples 14 to 25) or to any of the examples described herein, further comprising that the means is configured to run the code for the plurality of test cases on the function under test.

An example (e.g., example 27) relates to a method for generating code for test cases for testing a function under test, the method comprising obtaining (110) a diagram representation of the function under test. The method comprises selecting (120) a plurality of symbols of interest from the diagram representation of the function under test, the symbols of interest being based on a pre-defined set of symbols of interest. The method comprises generating (140), for the symbols of interest, code of a plurality of test cases based on a pre-defined set of checks related to the pre-defined symbols of interest.

Another example (e.g., example 28) relates to a previously described example (e.g., example 27) or to any of the examples described herein, further comprising that the pre-defined set of symbols of interest comprises one or more of a symbol of interest related to a branch condition, a symbol of interest related to an external function call, a symbol of interest related to an input/output parameter change, a symbol of interest related to a global variable change, a symbol of interest related to one or more pre-conditions imposed on a software or hardware environment, a symbol of interest related to a sequence of function calls and a symbol of interest related to a flow of a transition between different functions.

Another example (e.g., example 29) relates to a previously described example (e.g., one of the examples 27 to 28) or to any of the examples described herein, further comprising that the pre-defined set of symbols of interest comprises a symbol of interest related to a global variable change, the pre-defined set of checks comprising one or more of a check for ascertaining that a value of one or more global variables is set before the function under test is called and a check for ascertaining a correctness of the global variable change.

Another example (e.g., example 30) relates to a previously described example (e.g., one of the examples 27 to 29) or to any of the examples described herein, further comprising that the pre-defined set of symbols of interest comprises a symbol of interest related to an input/output parameter change, the pre-defined set of checks comprising a check for ascertaining that an input parameter is set before the function under test is called.

Another example (e.g., example 31) relates to a previously described example (e.g., one of the examples 27 to 30) or to any of the examples described herein, further comprising that the pre-defined set of symbols of interest comprises a symbol of interest related to one or more pre-conditions imposed on a software environment, the pre-defined set of checks comprising a check related to the one or more pre-conditions imposed on the software environment.

Another example (e.g., example 32) relates to a previously described example (e.g., one of the examples 27 to 31) or to any of the examples described herein, further comprising that the pre-defined set of symbols of interest comprises a symbol of interest related to an external function call, the pre-defined set of checks comprising one or more of a check related to a behavior of the external function call, a check related to an input parameter of the external function call, and a check related to an execution sequence dependency of the external function call.

Another example (e.g., example 33) relates to a previously described example (e.g., one of the examples 27 to 32) or to any of the examples described herein, further comprising that the pre-defined set of symbols of interest comprises a symbol of interest related to an external function call and/or a symbol of interest related to a global variable change, the pre-defined set of checks comprising a check related to an impact of the function under test on global memory or an external resource.

Another example (e.g., example 34) relates to a previously described example (e.g., one of the examples 27 to 33) or to any of the examples described herein, further comprising that the pre-defined set of checks comprises one or more of a check related to a change related to an output variable in the function under test and a check related to a return value of the function under test.

Another example (e.g., example 35) relates to a previously described example (e.g., one of the examples 27 to 34) or to any of the examples described herein, further comprising that the method comprises generating (140) the code for the plurality of test cases based one or more symbols of interest related to branch conditions.

Another example (e.g., example 36) relates to a previously described example (e.g., one of the examples 27 to 35) or to any of the examples described herein, further comprising that the method comprises recursively traversing (130) the symbols of interest to generate the code for the plurality of test cases.

Another example (e.g., example 37) relates to a previously described example (e.g., example 36) or to any of the examples described herein, further comprising that the method comprises recursively identifying (135) a plurality of different behaviors of the function under test and generating (140) the code for the plurality of test cases based on the plurality different behaviors of the function under test, each test case representing one behavior of the function under test.

Another example (e.g., example 38) relates to a previously described example (e.g., one of the examples 27 to 37) or to any of the examples described herein, further comprising that the diagram representation of the function under test is based on the unified modeling language.

Another example (e.g., example 39) relates to a previously described example (e.g., one of the examples 27 to 38) or to any of the examples described herein, further comprising that the method comprises running (150) the code for the plurality of test cases on the function under test.

An example (e.g., example 40) relates to a machine-readable storage medium including program code, when executed, to cause a machine to perform the method of one of the examples 27 to 39

An example (e.g., example 41) relates to a computer program having a program code for performing the method of one of the examples 27 to 39 when the computer program is executed on a computer, a processor, or a programmable hardware component.

An example (e.g., example 42) relates to a machine-readable storage including machine readable instructions, when executed, to implement a method or realize an apparatus as claimed in any pending claim or shown in any example.

The aspects and features described in relation to a particular one of the previous examples may also be combined with one or more of the further examples to replace an identical or similar feature of that further example or to additionally introduce the features into the further example.

As used herein, the term “module” refers to logic that may be implemented in a hardware component or device, software or firmware running on a processing unit, or a combination thereof, to perform one or more operations consistent with the present disclosure. Software and firmware may be embodied as instructions and/or data stored on non-transitory computer-readable storage media. As used herein, the term “circuitry” can comprise, singly or in any combination, non-programmable (hardwired) circuitry, programmable circuitry such as processing units, state machine circuitry, and/or firmware that stores instructions executable by programmable circuitry. Modules described herein may, collectively or individually, be embodied as circuitry that forms a part of a computing system. Thus, any of the modules can be implemented as circuitry. A computing system referred to as being programmed to perform a method can be programmed to perform the method via software, hardware, firmware, or combinations thereof.

Any of the disclosed methods (or a portion thereof) can be implemented as computer-executable instructions or a computer program product. Such instructions can cause a computing system or one or more processing units capable of executing computer-executable instructions to perform any of the disclosed methods. As used herein, the term “computer” refers to any computing system or device described or mentioned herein. Thus, the term “computer-executable instruction” refers to instructions that can be executed by any computing system or device described or mentioned herein.

Examples may further be or relate to a (computer) program including a program code to execute one or more of the above methods when the program is executed on a computer, processor, or other programmable hardware component. Thus, steps, operations, or processes of different ones of the methods described above may also be executed by programmed computers, processors, or other programmable hardware components. Examples may also cover program storage devices, such as digital data storage media, which are machine-, processor- or computer-readable and encode and/or contain machine-executable, processorexecutable or computer-executable programs and instructions. Program storage devices may include or be digital storage devices, magnetic storage media such as magnetic disks and magnetic tapes, hard disk drives, or optically readable digital data storage media, for example. Other examples may also include computers, processors, control units, (field) programmable logic arrays ((F)PLAs), (field) programmable gate arrays ((F)PGAs), graphics processor units (GPU), application-specific integrated circuits (ASICs), integrated circuits (ICs) or system-on-a-chip (SoCs) systems programmed to execute the steps of the methods described above.

The computer-executable instructions can be part of, for example, an operating system of the computing system, an application stored locally to the computing system, or a remote application accessible to the computing system (e.g., via a web browser). Any of the methods described herein can be performed by computer-executable instructions performed by a single computing system or by one or more networked computing systems operating in a network environment. Computer-executable instructions and updates to the computer-executable instructions can be downloaded to a computing system from a remote server.

Further, it is to be understood that implementation of the disclosed technologies is not limited to any specific computer language or program. For instance, the disclosed technologies can be implemented by software written in C++, C#, Java, Perl, Python, JavaScript, Adobe Flash, C#, assembly language, or any other programming language. Likewise, the disclosed technologies are not limited to any particular computer system or type of hardware.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, cable (including fiber optic cable), magnetic communications, electromagnetic communications (including RF, microwave, ultrasonic, and infrared communications), electronic communications, or other such communication means.

It is further understood that the disclosure of several steps, processes, operations, or functions disclosed in the description or claims shall not be construed to imply that these operations are necessarily dependent on the order described, unless explicitly stated in the individual case or necessary for technical reasons. Therefore, the previous description does not limit the execution of several steps or functions to a certain order. Furthermore, in further examples, a single step, function, process, or operation may include and/or be broken up into several sub-steps, -functions, -processes or -operations.

If some aspects have been described in relation to a device or system, these aspects should also be understood as a description of the corresponding method. For example, a block, device or functional aspect of the device or system may correspond to a feature, such as a method step, of the corresponding method. Accordingly, aspects described in relation to a method shall also be understood as a description of a corresponding block, a corresponding element, a property or a functional feature of a corresponding device or a corresponding system.

The disclosed methods, apparatuses, and systems are not to be construed as limiting in any way. Instead, the present disclosure is directed toward all novel and nonobvious features and aspects of the various disclosed embodiments, alone and in various combinations and subcombinations with one another. The disclosed methods, apparatuses, and systems are not limited to any specific aspect or feature or combination thereof, nor do the disclosed embodiments require that any one or more specific advantages be present or problems be solved.

Theories of operation, scientific principles, or other theoretical descriptions presented herein in reference to the apparatuses or methods of this disclosure have been provided for the purposes of better understanding and are not intended to be limiting in scope. The apparatuses and methods in the appended claims are not limited to those apparatuses and methods that function in the manner described by such theories of operation.

The following claims are hereby incorporated in the detailed description, wherein each claim may stand on its own as a separate example. It should also be noted that although in the claims a dependent claim refers to a particular combination with one or more other claims, other examples may also include a combination of the dependent claim with the subject matter of any other dependent or independent claim. Such combinations are hereby explicitly proposed, unless it is stated in the individual case that a particular combination is not intended. Furthermore, features of a claim should also be included for any other independent claim, even if that claim is not directly defined as dependent on that other independent claim.

1. An apparatus for generating code for test cases for testing a function under test, the apparatus comprising interface circuitry and processing circuitry to:
obtain a diagram representation of the function under test;
select a plurality of symbols of interest from the diagram representation of the function under test, the symbols of interest being based on a pre-defined set of symbols of interest; and
generate, for the symbols of interest, code of a plurality of test cases based on a pre-defined set of checks related to the pre-defined symbols of interest.

2. The apparatus according to claim 1, wherein the pre-defined set of symbols of interest comprises one or more of a symbol of interest related to a branch condition, a symbol of interest related to an external function call, a symbol of interest related to an input/output parameter change, a symbol of interest related to a global variable change, a symbol of interest related to one or more pre-conditions imposed on a software or hardware environment, a symbol of interest related to a sequence of function calls and a symbol of interest related to a flow of a transition between different functions.

3. The apparatus according to claim 1, wherein the pre-defined set of symbols of interest comprises a symbol of interest related to a global variable change, the pre-defined set of checks comprising one or more of a check for ascertaining that a value of one or more global variables is set before the function under test is called and a check for ascertaining a correctness of the global variable change.

4. The apparatus according to claim 1, wherein the pre-defined set of symbols of interest comprises a symbol of interest related to an input/output parameter change, the pre-defined set of checks comprising a check for ascertaining that an input parameter is set before the function under test is called.

5. The apparatus according to claim 1, wherein the pre-defined set of symbols of interest comprises a symbol of interest related to one or more pre-conditions imposed on a software environment, the pre-defined set of checks comprising a check related to the one or more pre-conditions imposed on the software environment.

6. The apparatus according to claim 1, wherein the pre-defined set of symbols of interest comprises a symbol of interest related to an external function call, the pre-defined set of checks comprising one or more of a check related to a behavior of the external function call, a check related to an input parameter of the external function call, and a check related to an execution sequence dependency of the external function call.

7. The apparatus according to claim 1, wherein the pre-defined set of symbols of interest comprises a symbol of interest related to an external function call and/or a symbol of interest related to a global variable change, the pre-defined set of checks comprising a check related to an impact of the function under test on global memory or an external resource.

8. The apparatus according to claim 1, wherein the pre-defined set of checks comprises one or more of a check related to a change related to an output variable in the function under test and a check related to a return value of the function under test.

9. The apparatus according to claim 1, wherein the circuitry is configured to generate the code for the plurality of test cases based one or more symbols of interest related to branch conditions.

10. The apparatus according to claim 1, wherein the circuitry is configured to recursively traverse the symbols of interest to generate the code for the plurality of test cases.

11. The apparatus according to claim 10, wherein the circuitry is configured to recursively identify a plurality of different behaviors of the function under test, and to generate the code for the plurality of test cases based on the plurality different behaviors of the function under test, each test case representing one behavior of the function under test.

12. The apparatus according to claim 1, wherein the diagram representation of the function under test is based on the unified modeling language.

13. The apparatus according to claim 1, wherein the circuitry is configured to run the code for the plurality of test cases on the function under test.

14-18. (canceled)

19. A method for generating code for test cases for testing a function under test, the method comprising:
obtaining a diagram representation of the function under test;
selecting a plurality of symbols of interest from the diagram representation of the function under test, the symbols of interest being based on a pre-defined set of symbols of interest; and
generating, for the symbols of interest, code of a plurality of test cases based on a pre-defined set of checks related to the pre-defined symbols of interest.

20. The method according to claim 19, further comprising generating the code for the plurality of test cases based one or more symbols of interest related to branch conditions.

21. The method according to claim 19, further comprising recursively traversing the symbols of interest to generate the code for the plurality of test cases.

22. The method according to claim 21, further comprising recursively identifying a plurality of different behaviors of the function under test and generating the code for the plurality of test cases based on the plurality different behaviors of the function under test, each test case representing one behavior of the function under test.

23. The method according to claim 19, further comprising running the code for the plurality of test cases on the function under test.

24. A machine-readable storage medium including program code, when executed, to cause a machine to perform the method of claim 19.
